(19) United States
(12) Patent Application Publication
(10) Pub. No.: US 2025/0025789 A1
(43) Pub. Date: Jan. 23, 2025

(54) METHOD AND APPARATUS PROVIDING A COMPUTER IMPLEMENTED GAME

(71) Applicant: KING.COM LIMITED, St. Julians (MT)

(72) Inventors: Jeffrey GAMSKY, Stockholm (SE); Matheus KNEBEL, Stockholm (SE); Marjana DRAGICEVIC, Malmo (SE)

(21) Appl. No.: 18/356,607

(22) Filed: Jul. 21, 2023

(51) Int. Cl. A63F 13/69; A63F 13/2145; A63F 13/44; A63F 13/533

(52) U.S. Cl. CPC A63F 13/69; A63F 13/2145; A63F 13/44; A63F 13/533

(57) ABSTRACT

A computer device is configured to provide a computer implemented match game. The computer device at least one processor configured to cause a display of the computer device to display one or more options, each option of the one or more options being associated with a game reward and a first defined time period. When one of the one or more options is selected by user input received via a user interface of the computer device, the reward associated with the selected option is available at the end of the first defined time period. The game reward being usable in one or more of a plurality of different levels of the of the computer implemented match game.

### FIELD OF THE INVENTION

Embodiments of this disclosure relate to a user device configured to provide a computer implemented game.

Some embodiments may relate to engaging users or players in a computer implemented game executable in an online or offline environment.

### BACKGROUND OF THE INVENTION

In the field of computer-implemented games, there are many technical challenges facing the designer of such computer implemented games when considering how, for example, the user interface is to be controlled in the context of computer devices available to play the computer implemented game.

One technical challenge can involve allowing a game to be fun and compelling even when there is limited display resource available, such as when a computer implemented game is being played on a smartphone, tablet, or other minicomputer.

Another significant challenge is that of user engagement. Engagement involves designing gameplay to be engaging and rewarding to players. This typically requires games to be easily understood at their simplest or introductory levels, providing rewarding gameplay with quite simple game mechanics, but becoming progressively more challenging so that players are not bored, but remain engaged and develop rewarding skills. Effective engagement requires various forms of feedback to reinforce player sense of success and accomplishment.

A common genre of casual games is so-called match games. This is a type of tile-matching game where the player manipulates tiles or game objects according to a matching criterion.

A match-three game is a type of casual puzzle game where the player is required to find patterns on a seemingly chaotic board. The player then has to match three or more of the same type of game element on the game board and those matched elements will then disappear. An existing type of match-three game is a so-called “switcher” game. In a switcher game, the player switches place of two adjacent game elements on the game board so that one or both of them create a chain of at least three adjacent game elements of the same type. Those matched game elements will then disappear. The game board is then repopulated with game objects.

One such known match three-type game is Candy Crush Saga. In that game, the game board is repopulated with game elements which are perceived as falling downwards onto the game board from the top edge of the screen from which the computer implemented game is played.

Another known type of match game is “linker game,” where a sequence of game elements are linked to form a known sequence.

Another type of match game is a ‘clicker’ game, in which matches can be made in a board by clicking a group of adjacent game elements.

A technical challenge exists in the providing of effective user engagement in a match game which has a relatively simple game when played on a user device with a relatively small screen such as smartphone or tablet.

This patent specification describes not only various ideas and functions, but also their creative expression. A portion of the disclosure of this patent document therefore contains material to which a claim for copyright is made and notice is hereby given: Copyright King.com Limited 2023 (pursuant to 17 U.S.C. 401). A claim to copyright protection is made to all screen shots, icons, look and feel and all other protectable expression associated with the games illustrated and described in this patent specification.

The copyright owner has no objection to the facsimile reproduction by anyone of the patent document or the patent disclosure, as it appears in the Patent and Trademark Office patent file or records, but reserves all other copyright rights whatsoever. No express or implied license under any copyright whatsoever is therefore granted.

### SUMMARY OF THE INVENTION

According to one aspect, there is provided a computer device configured to provide a computer implemented match game, the computer device comprising a display, a user interface, at least one memory, and at least one processor wherein: the at least one processor is configured to cause the display to display one or more options, each option of the one or more options being associated with a game reward and a first defined time period; the at least one processor is configured to determine that one of the one or more options has been selected, in response to user input received via the user interface; and the at least one processor is configured to make the reward associated with the selected option available at the end of the first defined time period, the game reward being usable in one or more of a plurality of different levels of the of the computer implemented match game,

The game reward may comprise one or more of: one or more booster game objects; in-game currency; one or more lives; unlimited lives; or one or more extra moves.

The at least one processor may be configured, in response to user input received via the user interface to claim the available reward, to provide the claimed game reward in one or more of the different levels of the computer implemented match game.

The at least one processor may be configured to determine if the available game reward has been claimed within a second defined time period, and when the at least one processor determines that the available game reward has not been claimed within the second defined time period, the game reward is no longer available.

The game reward may be usable in one or more of the different levels of the computer implemented match game during a third predefined time periods.

One or more of the options may be associated with one or more input items, and the at least one processor is configured to determine if the one or more input items for the selected option are available.

When the at least one processor determines that the one or more input items for the selected option are available, the at least one processor may be configured to make the game reward available at the end of the first defined time period.

When the at least one processor determines that the one or more input items for the selected option are not available, the at least one processor may be configured to cause the display to display an option for using in game currency, and in response to user input received via the user input selecting the option for using in game currency, the at least one processor is configured to make the game reward available at the end of the first defined time period.

The one or more input items may comprise: one or more booster game objects; one or more lives; and in game currency.

The at least one processor may be configured to refresh one or more options displayed on the display.

The at least one processor may be configured to refresh one or more options displayed on the display after a refresh period of time.

The at least one processor is configured to cause the display to display two or more options, each of the options having a slot, wherein when an option of the two or more options has been selected and the respective game reward has been used, the at least one processor is configured to fill the slot of the selected option only after the refresh period of time.

The at least one processor may be configured to allow only one option to be selected at a time.

At least two of the one or more options may be associated with different first defined time periods.

At least one option may be associated with one or more input items, the one or more input items comprising one or more booster game objects, and the at least one processor may be configured to determine if the one or more input items for the selected option are available, and when the at least one processor determines that the one or more input items for the selected option are available, the at least one processor is configured to make the game reward available at the end of the first defined time period, the game reward comprising one or more booster game objects different to the one or more input items.

According to another aspect, there is provided a computer method providing a computer implemented match game, the method being provided by a computer device configured to provide the computer implemented match game and comprising a display, a user interface, at least one memory, and at least one processor, the method comprising: causing, by the at least one processor the display to display one or more options, each option of the one or more options being associated with a game reward and a first defined time period; determining, by the at least one processor, that one of the one or more options has been selected, in response to user input received via the user interface; and making, by the at least one processor, the reward associated with the selected option available at the end of the first defined time period, the game reward being usable in one or more of a plurality of different levels of the of the computer implemented match game.

The game reward may comprise one or more of: one or more booster game objects; in-game currency; one or more lives; unlimited lives; or one or more extra moves.

The method may comprise providing, by the at least one processor, the claimed game reward in one or more of the different levels of the computer implemented match game, in response to user input received via the user interface to claim the available reward.

The method may comprise determining, by the at least one processor, if the available game reward has been claimed within a second defined time period, and when the available game reward has not been claimed within the second defined time period, the game reward is no longer available.

The game reward may be usable in one or more of the different levels of the computer implemented match game during a third predefined time periods.

One or more of the options may be associated with one or more input items, and the method may comprise determining, by the at least one processor, if the one or more input items for the selected option are available.

The method may comprise making, by the at least one processor, the game reward available at the end of the first defined time period, when the one or more input items for the selected option are available.

The method may comprise causing, by the at least one processor, the display to display an option for using in game currency when the one or more input items for the selected option are not available, and in response to user input received via the user input selecting the option for using in game currency, making, by the at least one processor, the game reward available at the end of the first defined time period.

The one or more input items may comprise: one or more booster game objects; one or more lives; and in game currency.

The method may comprise refreshing, by the at least one processor, one or more options displayed on the display.

The method may comprise refreshing, by the at least one processor, one or more options displayed on the display after a refresh period of time.

The method may comprise causing, by the at least one processor, the display to display two or more options, each of the options having a slot, wherein when an option of the two or more options has been selected and the respective game reward has been used, the method may comprise filing, by the at least one processor, the slot of the selected option only after the refresh period of time.

The method may comprise allowing, by the at least one processor, only one option to be selected at a time.

At least two of the one or more options may be associated with different first defined time periods.

At least one option may be associated with one or more input items, the one or more input items comprising one or more booster game objects, and the method may comprise determining, by the least one processor, if the one or more input items for the selected option are available, and making, by the least one processor, the game reward of the selected option available at the end of the first defined time period, when the one or more input items for the selected option are available, the game reward comprising one or more booster game objects different to the one or more input items.

According to some aspects, there is provided a program product comprising a computer-readable storage device including a computer-readable program for providing a computer-implemented game, wherein the computer-readable program when executed on a computer causes the computer to perform any one or more of the method steps described previously.

computer program comprising program code means adapted to perform the method(s) may also be provided. The computer program may be stored and/or otherwise embodied by means of a carrier medium.

In the above, many different embodiments have been described. It should be appreciated that further embodiments may be provided by the combination of any two or more of the embodiments described above.

Various other aspects and further embodiments are also described in the following detailed description and in the attached claims.

### BRIEF DESCRIPTION OF THE DRAWINGS

Embodiments will now be described by way of the accompanying drawings in which:

FIG. 1 is a schematic diagram of a game board of a match three computer implemented game illustrating a basic example of a match three game;

FIG. 2 is a schematic diagram illustrating how a game board of a match three computer implemented game is populated with replacement game elements;

FIG. 3 shows an example system in which some embodiments may be provided;

FIG. 4 shows an example user device configured to provide some embodiments;

FIG. 5 schematically provides an overview of some embodiments;

FIGS. 6a to 6i shows some example screens displayed in some embodiments;

FIG. 7 shows a method of some embodiments; and

FIG. 8 shows another method of some embodiments.

### DESCRIPTION OF PREFERRED EMBODIMENTS

The terms user and player are used interchangeably throughout this document and no specific meaning is intended using one or the other unless the context suggests otherwise.

In the following description of various implementations of the embodiments, reference is made to the accompanying drawings which form a part thereof, and in which is shown by way of illustration various implementations in which the invention may be utilized. It is to be understood that other implementations may be utilized, and structural and functional modifications may be made without departing from the scope of the present invention.

A person skilled in the art will realise that the different approaches to implementing the computer implemented game is not exhaustive, what is described herein are certain preferred embodiments. It is possible to implement the computer implemented game in a number of variations.

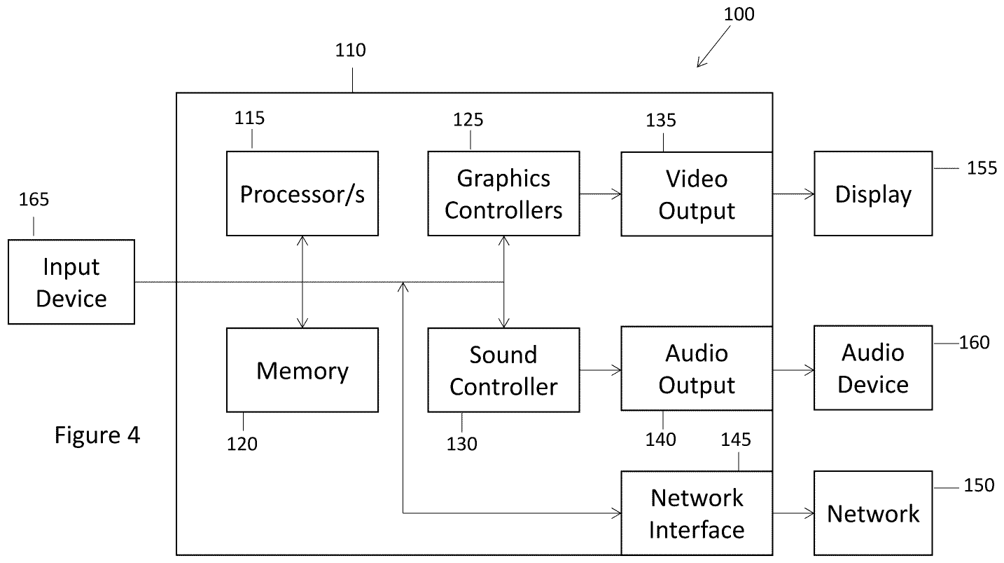

schematic view of a user device 100 according to an embodiment is shown in FIG. 4. All of the blocks shown are implemented by suitable circuitry. The blocks may be implemented in hardware and/or software. The user device may have a control part 110. The control part 110 is shown as having a graphics controller 125 and a sound controller 130. It should be appreciated that one or other or both of the graphics controller 125 and sound controller 130 may be provided by the one or more processors 115.

The graphics controller 125 is configured to provide a video output 135. The sound controller 130 is configured to provide an audio output 140. The control part 110 has an interface 145 allowing the device to be able to communicate with a network 150 such as the Internet or other communication infrastructure.

The video output 135 is provided to a display 155. The audio out 140 is provided to an audio device 160 such as a speaker and or earphone(s).

The device 100 has an input device 165. The input device can take any suitable format and can be one or more of a keyboard, mouse, touch screen, joystick, or game controller. It should be appreciated that the display 155 may in some embodiments also provide the input device 165 by way of an integrated touch screen for example.

The blocks of the control part 110 are configured to communicate with each other by an interconnect such as a bus or any other suitable interconnect and/or by point-to-point communication.

It should be appreciated that in some embodiments, the control part may be implemented by one or more integrated circuits, at least in part.

The user device 100 is shown by way of example only. In alternative embodiments, one or more of the parts may be omitted. Alternatively or additionally, some embodiments may comprise one or more other parts. Alternatively or additionally, one or more parts may be combined.

In some embodiments, the user device is configured to provide a computer implemented game of some embodiments. This is described in more detail later.

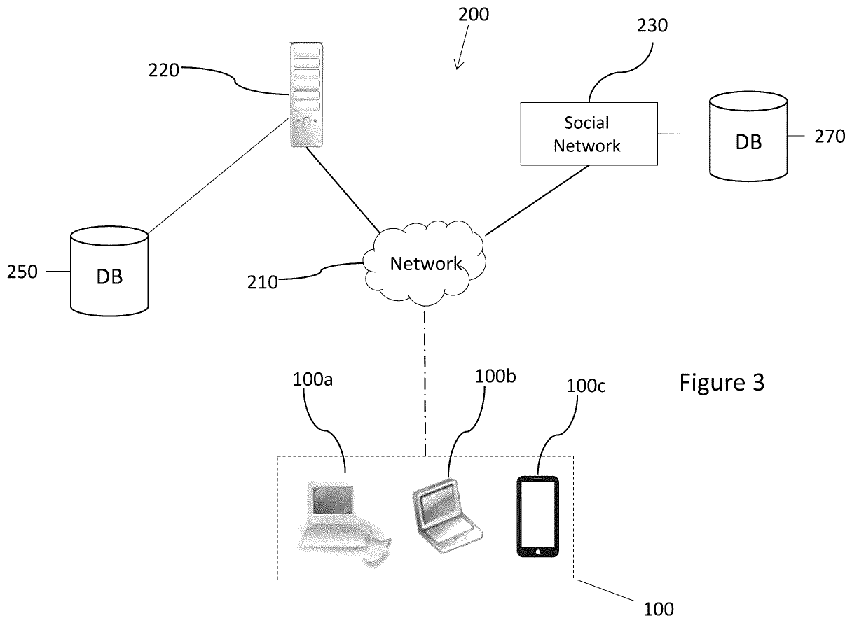

FIG. 3 schematically shows a system 200 supporting some embodiments. The system 200 comprises a server 220 which may store or be in communication with a database 250 which may store game player's details, profiles, statistics etc. In practice, one or more databases 250 may be provided. Where more than one server 220 is provided, the database(s) 250 may be provided in one server 220 or across two or more servers. The server 220 may also have a games data function. This may comprise one or more units of memory to store the computer implemented game program and user behaviour data, and a processor to run the games program and process the user behaviour data.

The server 220 may communicate via, for instance, the internet 210 with one or more client or user devices 100, shown in FIG. 3 by way of example as user devices 100a, 100b and 100c. There may be connections, via the network 210, to a social network 230, for example, Facebook™. The social network 230 may also be connected to a database 270 storing for example, social user interaction details, user to user interaction maps, friend lists, location history, and/or the like. In practice, one or more databases 270 may be provided.

It should be appreciated that embodiments may be deployed in different system architectures. For example, the computer implemented game may be implemented as a computer implemented game that is stored in the memory of the user device and is run on the at least one processor of the user device. However, the server 220 may handle some elements of the computer implemented game in some embodiments. By way of example only, a Java game applet may be provided to the user device 100 and the locally running Java applet will generate, for example, the graphics, sounds, and user interaction for the game play on the user device. Some data may be fed back to the server to allow interaction with other players. The data which is fed back may alternatively or additionally allow scoring and/or cross platform synchronization.

In some embodiments, the computer implemented game may be implemented as a computer program that is stored in a memory of the system, for example the server, and which runs on at least one processor of the game server. Data streams or updates are supplied to the user device to allow the user device to render and display graphics and sounds in a browser of the user device. Such an approach is sometimes referred to as a web services approach. It should be appreciated, however, that such an approach does not necessarily require the use of the Internet.

It should be appreciated that some embodiments may be provided as a stand-alone computer implemented game on the user device.

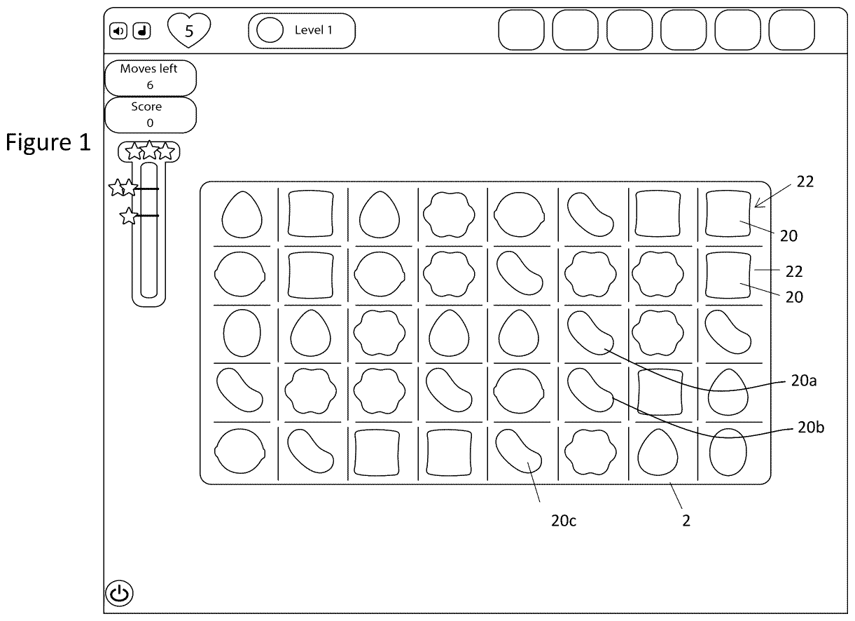

FIG. 1 shows a known version of a match 3 switcher computer implemented game called Candy Crush Saga™ which is displayed on a display of communication device. FIG. 1 illustrates a game board 2 with a plurality of game elements 20. The game elements are each of six different shapes and colours. Of course, in other embodiments, there may be more or less than six different game elements. Each game element type may be defined by one or more of particular characteristics, for example a particular shape and colour combination. Each game element is supported by a tile 22.

In the known version of the match 3 switcher game, the aim of the computer implemented game is to swap game elements in the shape of candies with each other to make moves on the game board. To gain points the player has to make moves that create matches of at least three of the same game element or candy. In doing so, the player gains points and the matched game elements are removed. As a result, new game elements fall into place from the top of the game board in order to fill any spaces created.

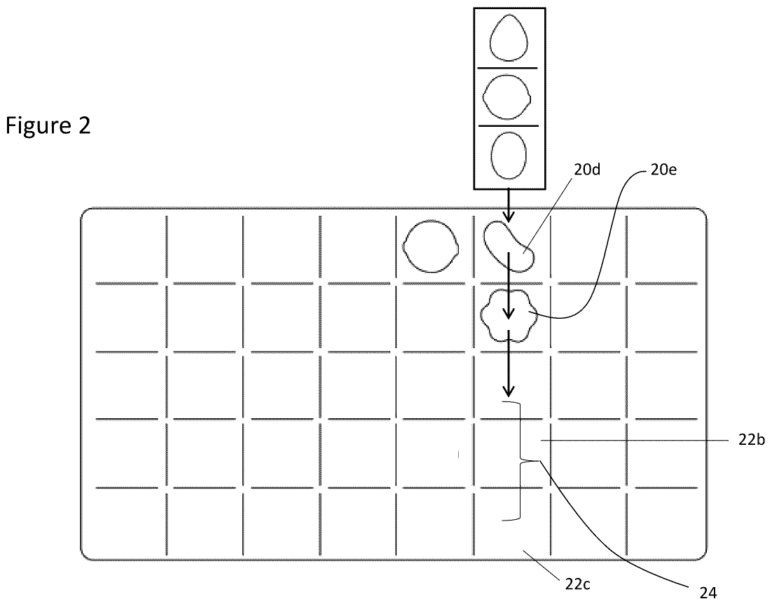

Assume in FIG. 1 that game element 20c is moved one place to the right to form a three-line match with game elements 20a and 20b. Turning now to FIG. 2, this has the effect of game elements 20a, 20b and 20c being removed or “disappearing” from the game board, creating a visual effect (animation) on the screen to indicate the disappearance, such as a minimal explosion effect. The two game elements which were directly above game elements 20a will now fall downwards into the spaces created by the removal of game elements 20a, 20b and 20c. Thus, game element 20e will end up at the location 22c, and game element 20d will end up at the location 22b. In addition, three new game elements are provided and fall downwards into the game board to fill the remaining three spaces above location 22b. The new game elements may be generated at random. The user then has a new game board on which to make a subsequent move in the computer implemented game.

Some embodiments may use so-called physics to control movement of game elements when replenishing a game board. For example, in this computer implemented game, game elements drop down from above the game board at set speeds and from the top of the game board. In an alternative version of this game, the physics can vary so that the speed and direction of replacement game elements can alter. It should be appreciated that the game physics described are by way of example and in other embodiments any suitable game physics may be used. In some embodiments, the replenishment of a game board may be controlled without the use of game physics.

A computer implemented game may comprise one or more levels. A given level may only be playable once one or more other levels have been played and successfully completed. A game board is made up of game positions or tiles each of which is covered by a respective game element or game object.

A booster game object is one which provides an effect on the game board when triggered. For example, a booster game object may remove a row or column of game elements, remove one or more blocking game elements, remove one or more game elements, and change one or more game elements from one type of game element to another type of game element. It should be appreciated that these are some examples of booster game objects. Alternative or additional examples of booster game objects may be used in some embodiments.

There are many different options for booster game objects. Some examples of booster game objects are now described. These are example booster game objects used in the Candy Crush game. It should be appreciated that the appearance of the booster is by way of example only.

Color Bomb: When combined with another piece of a certain color, the color bomb targets game elements of the same color on the game board and explodes them.

Striped Candies: When activated, this booster game object clears an entire row or column, of the game board.

Wrapped Candies: When triggered, this booster game object removes game elements surrounding the booster game object.

Jelly Fish: When triggered, this booster game object has an effect on game elements (e.g., to remove a game element or trigger a booster game object), which are usually relevant to the achieving of a game objective.

Coconut Wheel: This booster game object functions in a similar way to the striped candy booster game object but also turn the first three game elements that it removes into more striped candies, immediately activating them and causing a chain reaction.

Lollipop Hammer: This booster game object is used to remove a game element of the player's choosing.

UFO: When triggered, this booster game object provides crucial help on the game board. For example, this booster may create three wrapped candies at random locations on a gameboard, which promptly explode upon landing or provide different help.

Extra moves: When selected, this provides a given number of extra moves.

In some embodiments, a booster game object may be selected for use before a level is played. In some embodiments, a booster game object may be selected and used while the player is playing the level. In some embodiments, a booster game object may be used at an end of game, for example to provide extra moves.

A booster game object may be selected, for example, by the user providing user input via the user interface of the user device and this user input is used by the at least one processor to control the selection of the booster game object.

Alternatively, the selection of the booster game object may be controlled by the at least one processor.

In some embodiments, the position of a booster game object on a game board may be controlled by the at least one processor of the user device.

In some embodiments, the position of a booster game object on the game board may be controlled by the user. In this latter case, the user provides user input via the user interface of the user device and this user input is used by the at least one processor to control where the booster game object is positioned on the game board.

A user may have an inventory of one more booster game objects. A booster game object from the inventory may be deployed on the gameboard when the user is playing the game.

A player may have one or more booster game objects which the player finds of little use when playing the game or providing only a relatively small effect. These booster game objects can be converted to booster game objects which are of more use to the player.

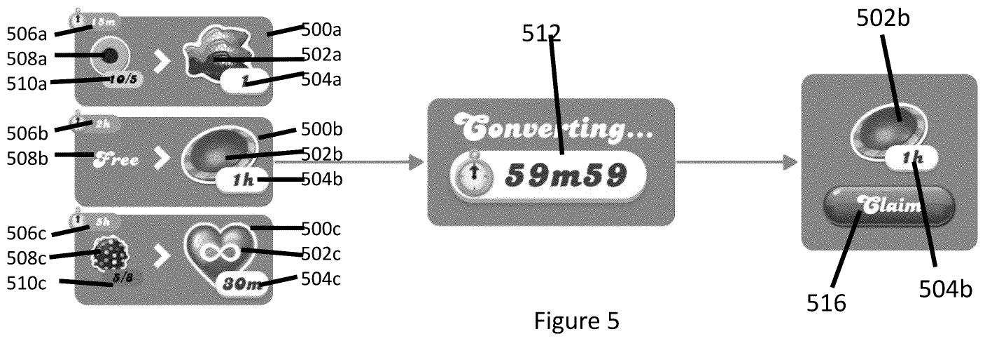

Reference is made to FIG. 5 which shows an overview of some embodiments.

In some embodiments, one or more input items may be converted into one or more game rewards.

For example, a booster game objects (input booster game object) from an inventory of the player may be converted into one or more different booster game objects (reward). The one or more input boosters may be the same type of booster or different booster. The one or more reward booster game objects may the same type of booster or different boosters.

In some embodiments, one or more booster game objects from an inventory of the player and/or other input item may be converted into a game reward. The game reward may be extra moves or extra lives or in game currency or one or more game booster objects.

The player may thus have the option of converting one or more booster game objects in the player's inventory into one or more better booster game objects and/or one or more booster game objects which the player prefers to use and/or one or more other game rewards.

In some embodiment, the rewards are provided after a first defined period of time. The first defined period of time may be different for different options.

In some embodiments, a reward may need to be claimed within a second defined period of time. The second defined period of time may be different for different rewards.

When a reward is claimed, it may be available for use during a third defined period of time, after the reward has been claimed. The third defined period of time may be different for different rewards.

Initially, the at least one processor of the user device is configured to cause the display to display one or more options. In the example shown in FIG. 5, three different options 500a are available.

In the example shown in FIG. 5, the first option 500a allows the conversion of a first booster game object 508a into a second booster game object 502a. The first booster game object is a coconut wheel, and the second booster game object is a jelly fish.

Information 510a is provided about the number of first booster game objects required and the number of first booster game objects in the inventory of the player. In this example, the 5 of the first booster are required and the user has 10 booster game objects in their inventory. Information 506a is provided which indicates the amount of time required to convert from the first booster to the second booster. In this example, the amount of time is 15 minutes. In this example, information 504a is provided as to availability of second booster game object. In this example, the booster has a onetime availability. In other words, the second booster game object can only be deployed once and once deployed once it is no longer available.

In the example shown in FIG. 5, the second option 500b provides a third booster game object 502b for free. The third booster game object is a UFO booster. Information 508b is provided that indicates that the third booster is provided for free. Information 506b is provided which indicates the amount of time required to provide a third booster game object. In this example, the amount of time is 2 hours. In this example, information 504b is provided as to the length of time for which the third booster is available. This may be from when the booster is claimed. In this example, the length of time for which the third booster is available is one hour. In other words, each time a player plays a new level or a new game (which may be a replay of a current or other level), the third booster will be available in the new level or the new game.

In the example shown in FIG. 5, the third option 500c allows the conversion of a fourth booster 508c into an unlimited lives option 502c. The fourth booster is a color bomb. Information 510c is provided about the number of fourth booster game objects required and the number of fourth booster game objects in the inventory of the player. In this example, the 8 of the fourth booster are required and the user has 5 of the fourth booster game objects in their inventory. Information 506c is provided which indicates the amount of time required to convert from the fourth booster to the unlimited lives option. In this example, the amount of time is 5 hours. In this example, information 504c is provided as to the length of time for which the unlimited lives are available. This may be from when the unlimited lives are claimed. In this example, the length of time for which the unlimited lives are available is 30 minutes. Thus, during the 30-minute period when the user is playing the game, the player may lose lives but will not run out of lives. This may be advantageous in games which have a limit on lives in a given time period and/or require the purchase of one or more lives with in-game currency.

When one of the options is selected, the at least one processor is configured to cause the remaining amount of time 512 for the providing of the game reward such as the resulting booster or unlimited lives to be displayed on the display.

When the time period has elapsed, the new booster or unlimited lives or other game reward can be claimed the player by selecting a claim option as referenced 516. In the example shown in FIG. 5, the second option has been selected and the third booster 502b is obtained. The at least one processor is configured to cause the display to display the third booster along with the information 504b as to the length of time for which the third booster is available when playing the game.

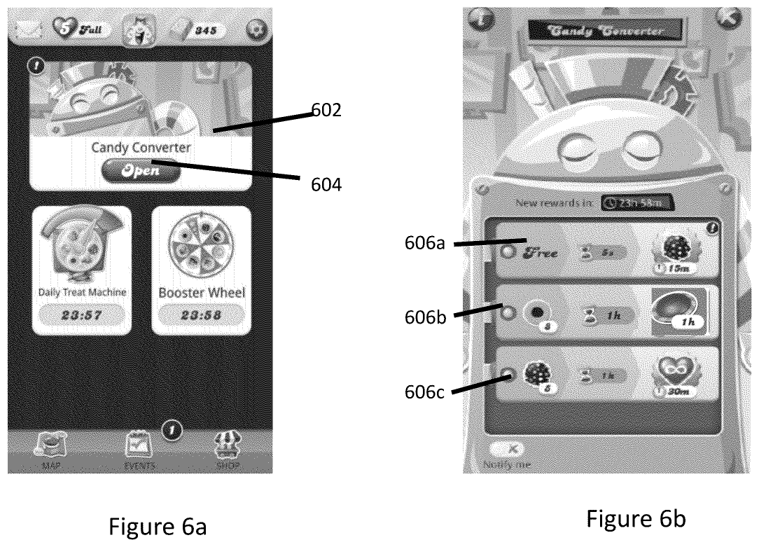

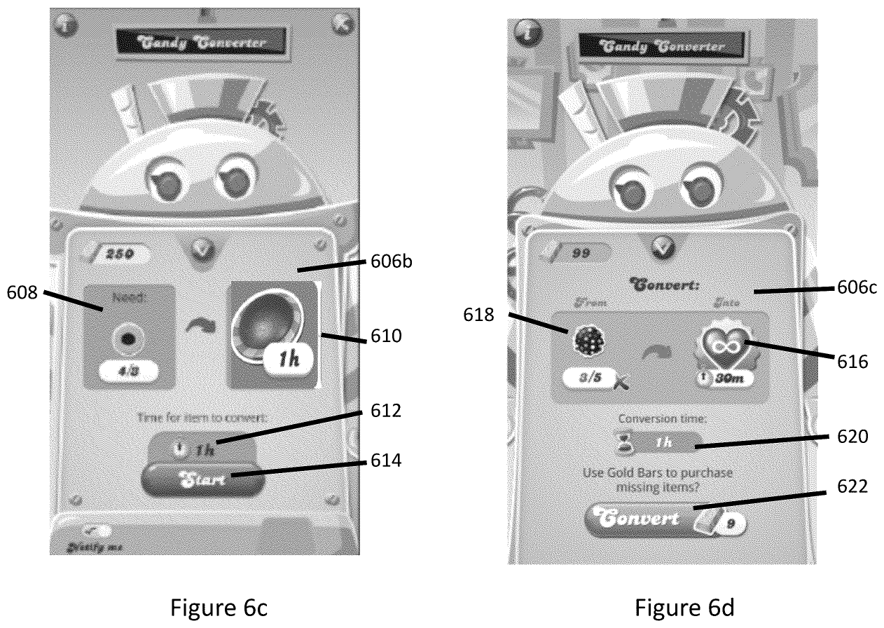

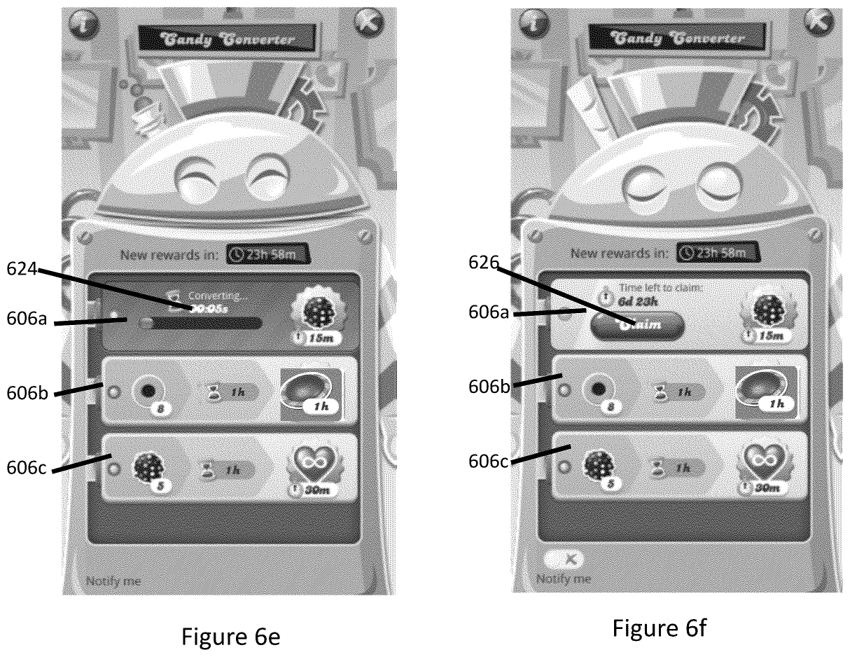

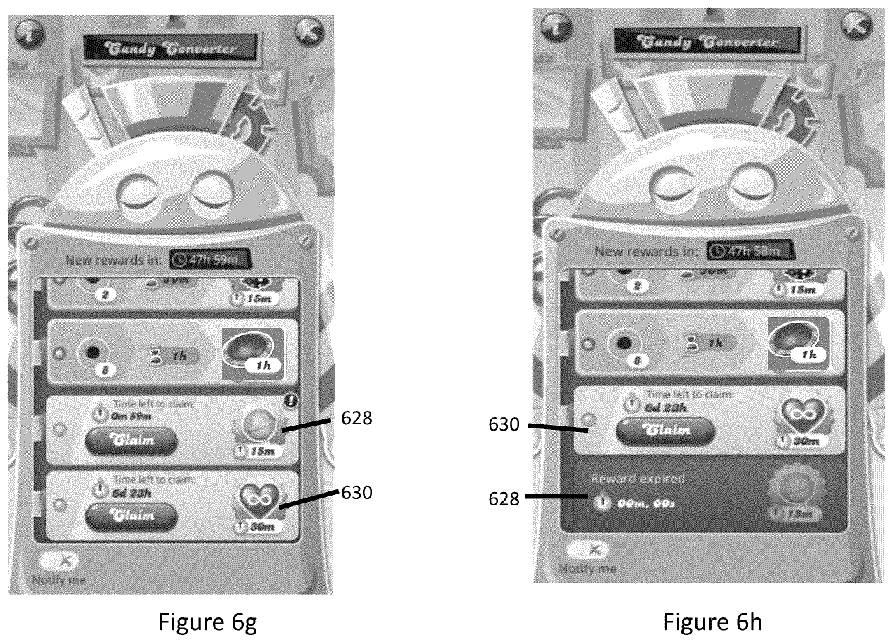

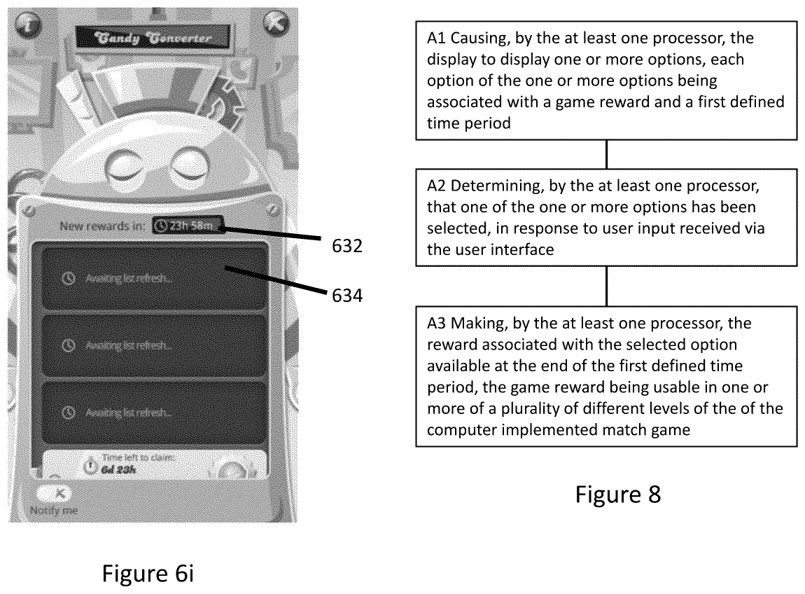

A more detailed example of the progress of some embodiments is shown in FIGS. 6a to 6i. These Figures show the display of the user device which is controlled by the at least one processor of the user device.

As shown in FIG. 6a, the at least one processor is configured to control the display to display a converter function 602. The converter function 602 is associated a user selectable area 604. The user selectable area 604 may comprise information inviting the user to select the converter function. It should be appreciated that the convertor function is provided by the at least one processor and the at least one memory of the user device. The at least one memory storing computer code which when run on the at least one processor cause the convertor function to be provided.

In the example shown in FIG. 6a, the user selectable area 604 is associated with the word “open”. This word is by way of example only and may be omitted in some embodiments.

In response to user input received via the user interface selecting the user selectable area 604, the converter function is selected and the at least one processor is configured to cause the display to display one or more converter options such as shown in FIG. 6b.

It should be appreciated that the user may be alternatively presented with the screen of FIG. 6b, without having to select the converter function such as outlined in relation to FIG. 6a. For example, the at least one processor may be configured to cause the display to display the converter options of FIG. 6b when the user has provided user input via the user interface to select a level of the game to play or when the player has finished playing a level.

FIG. 6b which shows the display displaying 3 converter options 606a, 606b and 606c.

In this example, the first converter option 606a provides a booster game object for free. This may be a color bomb booster. Information is provided that indicates that the booster game object is provided for free. Information is provided which indicates the amount of time required to provide the booster game object. In this example, the amount of time is 5 seconds. In this example, information is provided as to the length of time for which the booster game object is available for use. This may be from when the booster game object is claimed. In this example, the length of time for which the booster is available is 15 minutes. For example, the booster game object is provided in every game or in every new level which is played in that 15 minutes.

In this example, the second converter option 606b allows the conversion of one type of booster game object (e.g., a coconut wheel) into a different booster game object (e.g., a UFO). Information is provided about the number of booster game objects required for the conversion. In this example, 3 booster game objects are required. Information is provided which indicates the amount of time required to convert from one booster type to another booster type. In this example, the amount of time is one hour. In this example, information is provided as to the length of time for which the booster is available. This may be from when the booster is claimed. In this example, the length of time for which the booster is available is one hour. For example, the booster game object is provided in every game or in every new level which is played in that hour.

In this example, the third converter option 606c allows the allows the conversion of booster game object (e.g., a color bomb) into an unlimited lives option. Information is provided about the number of booster game objects required. In this example, the 5 booster game objects are required. Information is provided which indicates the amount of time required to convert from the booster game objects to unlimited lives option. In this example, the amount of time is 1 hour. In this example, information is provided as to the length of time for which the unlimited lives are available. This may be from when the unlimited lives are claimed. In this example, the length of time for which the unlimited lives are available is 30 minutes.

The user provides user input via the user interface to select one of the converter options. Where the display is a touch screen, the user input may be to touch one of the convertor options. In response to the user input, the at least one processor is configured to cause the display to display either the option shown in FIG. 6c, or the option shown in FIG. 6d.

Reference is made to FIG. 6c shows the display displaying the second converter option 606b which has been selected. Information 608 is provided about the number of booster game objects required for the conversion and the number of booster game objects which the player has. In this example, 3 booster game objects are required, and the player has 4 booster game objects. Information 612 is provided which indicates the amount of time required for the conversion. In this example, the amount of time is one hour. Information about the resulting booster and about the length of time for which the booster is available is displayed, as referenced 610. A user selectable area 614 is displayed on the display. When this user selectable area is selected by the user, this starts the conversion.

It should be appreciated that in other embodiments, when a converter option of FIG. 6b is selected, the converter option starts without causing the display to display the screen of FIG. 6c. In other words, no further input is required to start the converter option.

Reference is made to FIG. 6c which shows the display displaying the third converter option 606c which has been selected. Information 618 is provided about the number of booster game objects required for the conversion and the number of booster game objects which the player has. In this example, 5 booster game objects are required, and the player only has 3 booster game objects. In other words, the player does not have enough booster game objects for the conversion. Information 620 is provided which indicates the amount of time required for the conversion. In this example, the amount of time is one hour. Information that unlimited lives are provided by the conversion and about the length of time for which the unlimited lives are available is displayed, as referenced 616. In this example, the unlimited lives are available for 30 minutes from when they are claimed.

As the player does not have enough booster game objects for the conversion, the at least one processor is configured to cause the display to display an option for the player to use in-game currency to proceed with the conversion. A user selectable area 622 is displayed on the display with an indication of the amount of in game currency required to proceed with the conversion. In this example, the in-game currency is gold bars, and 9 gold bars are required for the conversion. When this user selectable area is selected by the user by providing user input via the user interface, the at least one processor is configured to start the conversion. The amount of in game currency is reduced by the at least one processor by the amount of in game currency required to proceed with the conversion.

Reference is made to FIG. 6e which shows the display displaying the 3 converter options 606a, 606b and 606c. This is similar to the screen shown in FIG. 6b, but in this example, the first converter option 606a has been selected. As can be seen, the first converter option is displayed with information 624 indicating a remaining amount of time. The remaining amount of time may be updated in real time. This may be shown graphically by a progress bar and/or by displaying the remaining time itself. Information may be displayed on the display indicating that a conversion is in progress. For example, this may be explicit or implicit. In the case of explicit information, the words “converting” or similar may be displayed. The time information may be used to implicitly indicate that the conversion is in progress.

Reference is made to FIG. 6f which shows the display displaying the 3 converter options 606a, 606b and 606c after the first converter option 606a has been selected and the conversion completed. As can be seen, the at least one processor is configured to cause the display to display the first converter option with a user selectable area 626 which when selected by user input received via the user interface, allows the player to claim the booster resulting from the conversion.

The at least one processor may be configured to cause the display to display information indicating a second defined time period in which the booster needs to be claimed. In this example, the booster game object needs to be claimed in 6 days and 23 hours. The at least one processor may be configured to update the remaining time left to claim the booster. The at least one processor may be configured to cause the display to display updated time. Different game rewards may have the same or different time periods as the second defined time period.

In some embodiments, the at least one processor is configured to cause a notification to be provided to the user indicating that the game reward is available to be claimed. This may be useful where the user is not playing the game or where the user is playing a game level. In that way, the user may be made aware that the game reward is available.

Reference is made to FIG. 6g which shows a display where the player has two different converted items 628 and 630 to claim. Each item is displayed with a user selectable area which when selected by user input, allows the player to claim the game reward resulting from the conversion. Information may be displayed for each of these options indicating the second defined time period in which the game reward needs to be claimed.

Reference is made to FIG. 6h which shows a display where one of the converted items 628 is no longer available to be claimed. In other words, the game reward has expired as the player did not claim that game reward in the associated second defined time period. In this example, the other game reward 630 is still available to be claimed. However, the remaining amount of time available to claim that other game reward will be getting smaller. In some embodiments, the at least one processor is configured to cause a message to be sent to the user when a game reward is about to expire and/or when a game reward has expired.

In some embodiments, the converter options available to a user will only be updated or refreshed after a given amount of time (a refresh time). In this regard, reference is made to FIG. 6i which shows a screen where the player has selected 3 of the available converter options and the resulting game reward has either been claimed or expired. In this example, the player needs to wait an amount of time (the refresh time) before new converter options are displayed. The at least one processor is configured to cause the display to display information 632 indicating when the next converter options will be available or how long until the next convertor options are available.

In some embodiments, the at least one processor may be configured to cause the display to display in empty slot 634 of the converter option information indicating when refreshing of the converter options will occur. When the convertor options are refreshed, an empty slot 634 will be filled with a new converter option.

In some embodiments, when a refresh time for new or refreshed options expires, the at least one processor is configured such that the converter option slots may be refreshed. In other words, previous converter option which have not been selected may be refreshed and may be replaced with a different convertor option. Unclaimed and unexpired options may be retained as discussed previously.

In some embodiments, only the empty slots may be refreshed. The previous converter options which have not been selected may be retained for at least one refresh. In some embodiments, a converter option is retained in any refresh until that convertor option is selected by the user.

In some embodiments, a conversion which has started but not completed before the convertor options are refreshed will be allowed to complete and the game reward to be subsequently claimed.

In other embodiments, a conversion which has started but not completed before the convertor options are refreshed will be lost, that is removed from the convertor options and replaced by a fresh converter option.

In some embodiments, when the new options are available, the unclaimed rewards which have not yet expired may be moved to the bottom of the list.

In some embodiments, the options may refresh every day or every n days. In other embodiments, the refreshing of options may be less than every day or longer than a day.

The options may refresh at a given time. For example, the options may refresh at the same time every day or every n days.

In some embodiments, the user may be provided with an option to refresh the convertor options before the expiry of the refresh period. This may require the user to use in game currency, to complete a game related task, or may be provided as a “free option” for the user. There may be a limit on the number of times that the user is able to refresh the convertor options before the expiry of the refresh period. The user refresh may be a partial refresh or a full refresh such as previously described. In a partial refresh one or more but not all of the slots may be refreshed.

In some embodiments, the options may be refreshed, not at the end of a given time period, but alternatively or additionally in response to game related activity such as the user completing a special mission, or playing n levels, or completing a hard level or any other game related activity. In this latter example, there may be no refresh period.

It should be appreciated that in some embodiments, a user may be able to scroll through the options where all the options are unable to be displayed on the display at the same time.

In some embodiments, the options that are displayed to a user will vary so that the user is not always presented with the same options.

Various different converter options have been described. However, these are by way of example only.

In some embodiments, an option is associated with a first predefined time. The length of the first predefined time associated with the option may be dependent on the considered worth of the game reward associated with the option or may be selected at random. In some embodiments, a default time may be associated with an option.

In some embodiments, in game currency may be used to skip or reduce the first predefined time.

In some embodiments, the result of the convertor option will be a reward. The game reward may comprise one or more booster game objects. Alternatively, the game reward may be associated with a benefit when applied in the game, such as extra lives, unlimited lives, or extra moves. Alternatively, the game reward may be in game currency.

In some embodiments, the game reward is provided after a given amount of time, when that option is selected. In some embodiments, one or more of the options may not be associated with any delay and may be immediately provided.

In some embodiments, the first predefined time associated with a game reward may be reduced or ended if an option provided by the at least one processor is selected. This may require the use of in game currency.

In some embodiments, the game reward requires one or more input item. The input items may comprise one or more booster game objects. Where two or more booster game objects are required, they may be of the same type or be a plurality of different types of booster. The input item may be in game currency. The input item may be one or more lives.

In some embodiments, if the user does not have all the required input items, in game currency may be used.

In some embodiments, reference has been made to in-game currency. The in-game currency may be gold bars.

In some embodiments, instead of in-game currency (other than in the context of the resulting reward), the user may be required to complete a task or action. For example, the task or action may be to require the user to watch an advertisement or other content. In another example, the task or action may be game related. For example, the player may be required to complete one or more game related tasks. Examples of game related tasks comprise completing a given number of levels (optionally on a first attempt) in a given time period, completing a given number of so-called hard levels, or achieving a threshold number of points.

In some embodiments, the at least one processor is configured to prevent the user from having more than one converter option in progress, that is with an unexpired timer and the game reward not yet provided. In other embodiments, the at least one processor is configured to allow the user to have more than one converter option in progress, that is with an unexpired timer and the game reward not yet provided.

In some embodiments, one or more of the options may be labelled to give an indication of a rarity of that option. In one embodiment, each option is labelled. In other embodiments only rare options are labelled.

In some embodiments, one or more options may be seasonal. Such options may be labelled as such.

In some embodiments, a player may be rewarded with additional game rewards when they have successfully made a given number of conversions. This may be time limited or may not be time limited. For example, a player may be provided with an additional game reward if the player has completed 10 conversions in a week. The number of conversions is only by of example, and other embodiments may require more or less than 10 conversions. The period of time is only by way of example, and other embodiments may have a time of more or less than one week. In some embodiments, the at least one processor may be configured to cause the display to display information as to the progress of the player in achieving the given number of conversions. This may be way of a progress bar or in any other suitable way.

In some embodiments, a player may be provided with an additional game reward if the player manages to convert all of the available options before the player is next able to refresh the convertor options.

In some embodiments, the user may be present with only a single converter option at a time.

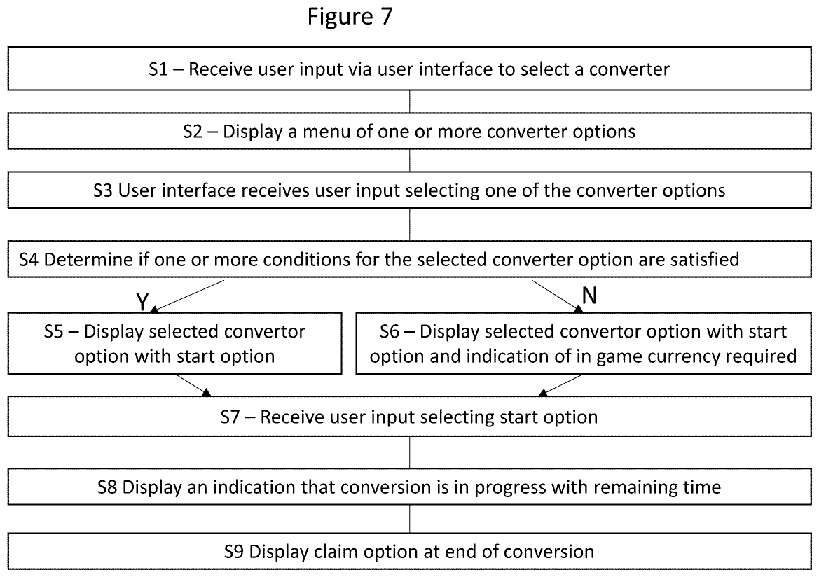

Reference is made to FIG. 7 which shows a method according to some embodiments. The method may be performed by at least one processor in conjunction with at least one memory of the user device.

In step S1, user input is received via the user interface to select a converter. When the converter is selected, the converter is able to provide once or more convertor options to the player.

This may be optional. In other embodiments, the converter may be provided when a given option or game level is selected by the player.

In step S3, the at least one processor is configured to cause one or more selectable converter options to be displayed.

In step S3, user input is received via the user interface to select one of the selectable converter options.

In step S4, the at least one processor is configured to determine if one or more of the conditions for the selected converter option is satisfied. This may for example be to check that the player has enough of a first type of booster.

If the at least one processor determines that the one or more conditions for the selected option are satisfied, then the next step is step S5. In step S5, the at least one processor is configured to display the selected converter option with a user selectable area which when selected starts the conversion of the selected option.

If the at least one processor determines that the one or more conditions for the selected option are not satisfied, then the next step is step S6. In step S6, the at least one processor is configured to display the selected converter option with a user selectable area which if selected will allow the conversion of the selected option to start with the use of in-game currency. The at least one processor is configured to cause the display to display an indication of the amount of in game currency required.

Where the player selects the user selectable area of step S5 or S6, via the user input, the conversion of the selected option is started in step S7.

In step S8, the at least one processor is configured to cause the display to display an indication that the conversion is in progress and an indication of a remaining amount of time.

In step S9, the at least one processor is configured to cause the display to display a claim option at the end of the conversion.

Reference is made to FIG. 8 which shows a method of some embodiments.

This method may be performed by user device.

The method may be provided by computer program code or computer executable instructions.

The method may comprise as referenced A1, causing, by the at least one processor the display to display one or more options, each option of the one or more options being associated with a game reward and a first defined time period.

The method may comprise as referenced A2, determining, by the at least one processor, that one of the one or more options has been selected, in response to user input received via the user interface.

The method may comprise as referenced A3, making, by the at least one processor, the reward associated with the selected option available at the end of the first defined time period, the game reward being usable in one or more of a plurality of different levels of the of the computer implemented match game.

It should be appreciated that the method outlined in FIG. 8 may be modified to include any of the previously described features.

It should be appreciated that embodiments may be used with any suitable matching game having a game board with game elements which are to be matched. The matching game can be a clicker game, a switcher game or linker game. The matching game may be a match 3 game where three or more game elements need to be matched in order to be removed from the game board.

Various methods and devices have been described. It should be appreciated that these methods may be implemented in apparatus or devices comprising any suitable circuitry. Some embodiments may be implemented by at least one memory and at least one processor. The memory is provided by memory circuitry and the processor is provided by processor circuitry. Some embodiments may be provided by a computer program running on the at least one processor. The computer program may comprise computer implemented instructions which are stored in the at least one memory and which may be run on the at least one processor. A computer program product may be provided which comprises computer program product comprising code embodied on a computer-readable medium which is configured to be executed on a processor of the computer or user device. In some embodiments, a non-transitory computer readable storage device may be provided to store program code instructions that, when executed by at least one processor causes any of the above described methods to be performed.

A person skilled in the art will realise that the different approaches to implementing the computer implemented game is not exhaustive, what is described herein are certain preferred embodiments. It is possible to implement the way in a number of variations without departing from the scope of the invention as claimed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer device configured to provide a computer implemented match game, the computer device comprising a display, a user interface, at least one memory, and at least one processor wherein:
the at least one processor is configured to cause the display to display one or more options, each option of the one or more options being associated with a game reward and a first defined time period;
the at least one processor is configured to determine that one of the one or more options has been selected, in response to user input received via the user interface; and
the at least one processor is configured to make the reward associated with the selected option available at the end of the first defined time period, the game reward being usable in one or more of a plurality of different levels of the of the computer implemented match game.

2. The computer device as claimed in claim 1, wherein game reward comprises one or more of:
one or more booster game objects;
in-game currency;
one or more lives;
unlimited lives; or
one or more extra moves.

3. The computer device as claimed in claim 1, wherein the at least one processor is configured, in response to user input received via the user interface to claim the available reward, to provide the claimed game reward in one or more of the different levels of the computer implemented match game.

4. The computer device as claimed in claim 3, wherein the at least one processor is configured to determine if the available game reward has been claimed within a second defined time period and when the at least one processor determines that the available game reward has not been claimed within the second defined time period, the game reward is no longer available.

5. The computer device as claimed in claim 3, wherein the game reward is usable in one or more of the different levels of the computer implemented match game during a third predefined time period.

6. The computer device as claimed in claim 1, wherein one or more of the options is associated with one or more input items, and the at least one processor is configured to determine if the one or more input items for the selected option are available.

7. The computer device as claimed in claim 6, wherein when the at least one processor determines that the one or more input items for the selected option are available, the at least one processor is configured to make the game reward available at the end of the first defined time period.

8. The computer device as claimed in claim 6, wherein when the at least one processor determines for the selected option that the one or more input items for the selected option are not available, the at least one processor is configured to cause the display to display an option for using in game currency and in response to user input received via the user input selecting the option for using in game currency, the at least one processor is configured to make the game reward available at the end of the first defined time period.

9. The computer device as claimed in claim 6, wherein the one or more input item comprise:
one or more booster game objects;
one or more lives; and
in game currency.

10. The computer device as claimed in claim 1, wherein the at least one processor is configured to refresh one or more options displayed on the display.

11. The computer device as claimed in claim 10, wherein the at least one processor is configured to refresh one or more options displayed on the display after a refresh period of time.

12. The computer device as claimed in claim 10, wherein the at least one processor is configured to cause the display to display two or more of the options, each of the options having a slot, wherein when an option of the two or more options has been selected and the respective game reward has been used, the at least one processor is configured to fill the slot of the selected option only after the refresh period of time.

13. The computer device as claimed in claim 1, wherein the at least one processor is configured to allow only one of the one or more options to be selected at a time.

14. The computer device as claimed in claim 1, wherein at least two of the one or more options are associated with different first defined time periods.

15. The computer device as claimed in claim 1, wherein at least one option of the one or more options is associated with one or more input items, the one or more input items comprising one or more booster game objects, and the at least one processor is configured to determine if the one or more input items for the selected option are available, when the at least one processor determines that the one or more input items for the selected option are available, the at least one processor is configured to make the game reward available at the end of the first defined time period, the game reward comprising one or more booster game objects different to the one or more input items.

16. A computer method providing a computer implemented match game, the method being provided by a computer device configured to provide the computer implemented match game and comprising a display, a user interface, at least one memory, and at least one processor, the method comprising:
causing, by the at least one processor, the display to display one or more options, each option of the one or more options being associated with a game reward and a first defined time period;
determining, by the at least one processor, that one of the one or more options has been selected, in response to user input received via the user interface; and
making, by the at least one processor, the reward associated with the selected option available at the end of the first defined time period, the game reward being usable in one or more of a plurality of different levels of the of the computer implemented match game.

17. The computer method as claimed in claim 16, wherein game reward comprises one or more of:
one or more booster game objects;
in-game currency;
one or more lives;
unlimited lives; or
one or more extra moves.

18. The computer method as claimed in claim 16, wherein one or more of the options is be associated with one or more input items, and the method comprises determining, by the at least one processor, if the one or more input items for the selected option are available.

19. The computer device as claimed in claim 18, wherein the one or more input item comprise:
one or more booster game objects;
one or more lives; and
in game currency.

20. A non-transitory computer program product comprising instructions which, when implemented by a at least one processor, cause a computer device to be configured to provide a computer implemented match game, the at least one processor being configured to:
cause a display of the computer device to display one or more options, each option of the one or more options being associated with a game reward and a first defined time period;
determine that one of the one or more options has been selected, in response to user input received via a user interface of the computer device; and
make the reward associated with the selected option available at the end of the first defined time period, the game reward being usable in one or more of a plurality of different levels of the of the computer implemented match game.
